(19) United States
(12) Patent Application Publication
(10) Pub. No.: US 2011/0193775 A1
(43) Pub. Date: Aug. 11, 2011

(54) OPTICAL POINTING DEVICE

(76) Inventors: Jae Kwang Lee, Gyunggi-do (KR); Dong Ik Shin, Gyunggi-do (KR); Victor Yurlov, Gyunggi-do (KR)

(21) Appl. No.: 12/821,519

(22) Filed: Jun. 23, 2010

(30) Foreign Application Priority Data
Feb. 10, 2010 (KR) 10-2010-0012458

(51) Int. Cl. G09G 5/08

(52) U.S. Cl. 345/157

(57) ABSTRACT

Disclosed herein is an optical pointing device. The device includes a light source which emits light. A guiding plate includes grooves formed in a thickness direction thereof, light emitted from the light source is incident on the guiding plate to move therealong, and the moving light collides with the grooves to be diffused therefrom. A first condensing part is provided under the guiding plate, and condenses light which is diffused from the grooves and reflected from a subject placed on the guiding plate. An image sensor is provided under the first condensing part.

### CROSS REFERENCE TO RELATED APPLICATION

This application claims the benefit of Korean Patent Application No. 10-2010-0012458, filed on Feb. 10, 2010, entitled “Optical Pointing Device”, which is hereby incorporated by reference in its entirety into this application.

### BACKGROUND OF THE INVENTION

1. Technical Field

The present invention relates to an optical pointing device.

2. Description of the Related Art

A conventional personal portable device generally uses a keypad type input device.

The input device, which is applied to the conventional personal portable device, includes a plurality of buttons for inputting numbers and letters, and allows a user to input an intended phone number or sentence in accordance with the defined function of each button.

Recently, as graphic data is able to be displayed on the display part of the personal portable device, it is possible to use the display part two-dimensionally. Here, a desired function may be set or performed by using a menu key and other function keys as direction keys.

However, recently, personal portable devices have changed to become similar to personal computers in terms of function, and have been developed with a reduced size in terms of design. Thus, a variety of information is provided to the display part, and fine adjustments are needed to select information required by a user.

When a phone number is input or other menus are used on the conventional keypad type input unit, a single movement method of moving only one space is performed. However, the single movement method is problematic in that it is very complicated and inconvenient to input a number or a letter or to select a desired menu.

Further, smart mobile phones have been developed recently. A Graphic User Interface (GUI) environment, such as Windows, is applied to the smart mobile phone, so that the conventional single movement method causes a user a feeling of inconvenience.

Thus, recently, novel pointing devices other than the conventional keypad type input unit have been developed. Examples of the pointing device include a mouse (optical mouse, laser mouse) for a computer, a touch pad, a tablet, etc.

The conventional pointing device may be theoretically applied to personal portable devices. However, since the personal portable device must be handy to carry, there is a limit to the actual application of an additional pointing device separated from a main body to the personal portable device.

In order to overcome such a limit, research into a pointing device which is directly mounted to the personal portable device, for example, a trackball type device, a joystick type device, and an optical type device, has been conducted recently. Among them, the trackball- or joystick-type device is problematic because, when mounted to the personal portable device, the trackball- or joystick-type device occupies a considerable physical space, thus negatively affecting the slimness of the personal portable device.

Further, the conventional optical type pointing device directly radiates light onto a subject for light to be input, and to this end a plurality of lenses or mirrors is used, thus imposing restrictions on the design of the pointing device.

The conventional optical type pointing device is problematic in that light is transmitted from the outside to an image sensor and thus generates noise, thereby resulting in the malfunction of the pointing device.

### SUMMARY OF THE INVENTION

The present invention has been made in an effort to provide an optical pointing device, which does not directly radiate light onto a subject but radiates light to a guiding plate which is in contact with the subject, thus realizing a slim structure.

Further, the present invention has been made in an effort to provide an optical pointing device, which includes a polarizing part so as to remove noise transmitted from the outside.

In an optical pointing device according to an embodiment of the present invention, a light source emits light. A guiding plate includes grooves formed in a thickness direction thereof, light emitted from the light source is incident on the guiding plate to move therealong, and the moving light collides with the grooves to be diffused therefrom. A first condensing part is provided under the guiding plate, and condenses light which is diffused from the grooves and reflected from a subject placed on the guiding plate. An image sensor is provided under the first condensing part.

The light source may be positioned at a side of the guiding plate.

The optical pointing device may further include a second condensing part between the light source and the guiding plate.

The second condensing part may be a diffusion lens.

The optical pointing device may further include a first polarizing part provided between the light source and the guiding plate and having first directivity.

The grooves may have the shape of dots and be formed in a matrix array.

The grooves may have the shape of slits extending in a length or width direction.

The optical pointing device may further include a protective layer formed on the guiding plate.

Further, the protective layer may be formed to cover the grooves.

Further, the protective layer may be a visible light blocking film which blocks external light of a visible light band.

Further, the guiding plate may be an optical waveguide.

The optical pointing device may further include a second polarizing part provided between the guiding plate and the image sensor and having second directivity.

Further, the second polarizing part may be a polarizing film formed on a lower surface of the guiding plate.

The optical pointing device may further include a visible light blocking part between the guiding plate and the image sensor.

The optical pointing device may further include a first polarizing part provided between the light source and the guiding plate and having first directivity, and a second polarizing part provided between the guiding plate and the image sensor and having second directivity.

The directivity of the first polarizing part may be perpendicular to the directivity of the second polarizing part.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view illustrating an optical pointing device according to a first embodiment of the present invention;

FIG. 2 is a plan view illustrating a guiding plate included in the optical pointing device of FIG. 1;

FIGS. 3 and 4 are a sectional view and a plan view, respectively, illustrating a modification of the optical pointing device shown in FIGS. 1 and 2;

FIGS. 5 and 6 are sectional views illustrating the operation of the optical pointing device shown in FIGS. 1 and 2;

FIGS. 7 to 11 are sectional views illustrating optical pointing devices according to second to sixth embodiments of the present invention;

FIG. 12 is a plan view illustrating an optical pointing device according to a seventh embodiment of the present invention;

FIGS. 13 and 14 are sectional views illustrating the optical pointing device of FIG. 12; and

FIG. 15 is a plan view illustrating a portable device equipped with an optical pointing device according to a preferred embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. Herein, the same reference numerals are used throughout the different drawings to designate the same components. Further, when it is determined that the detailed description of the known art related to the present invention may obscure the gist of the present invention, the detailed description will be omitted.

Hereinafter, optical pointing devices according to the preferred embodiments of the present invention will be described in detail with reference to the accompanying drawings.

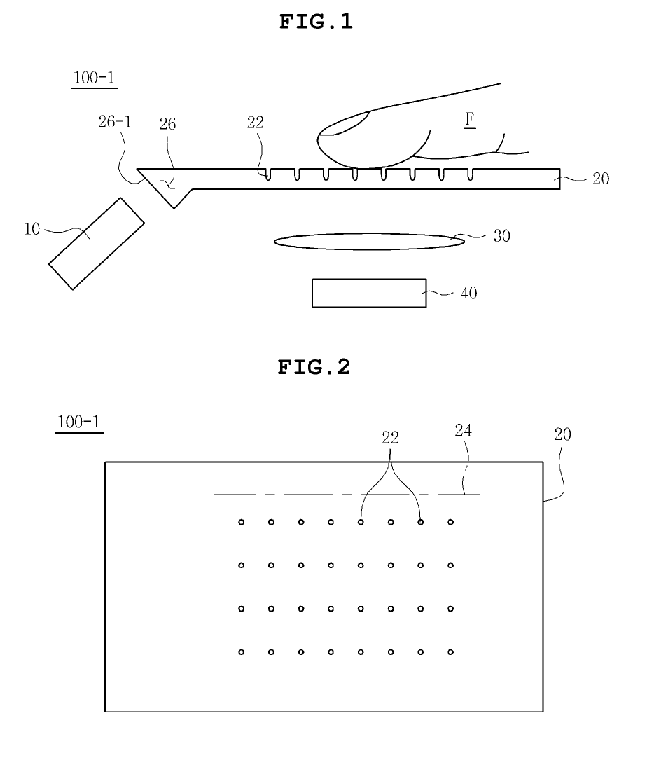

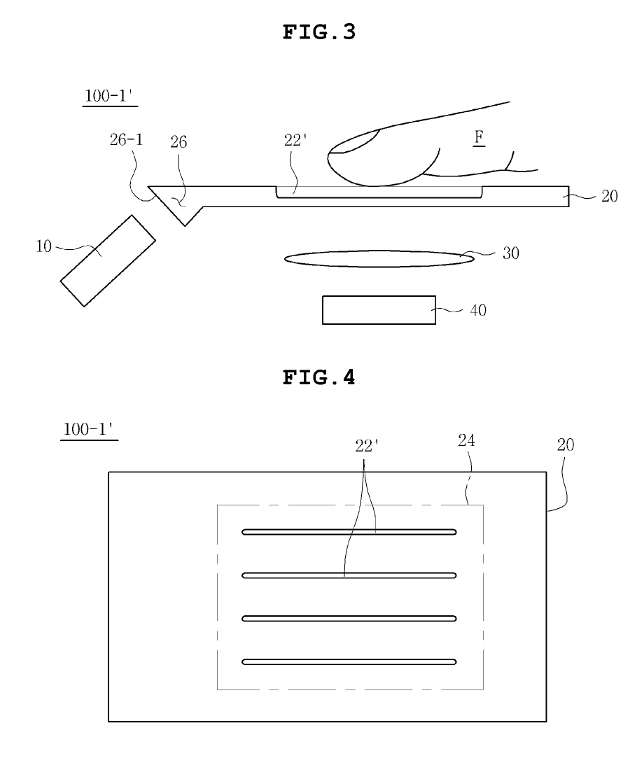

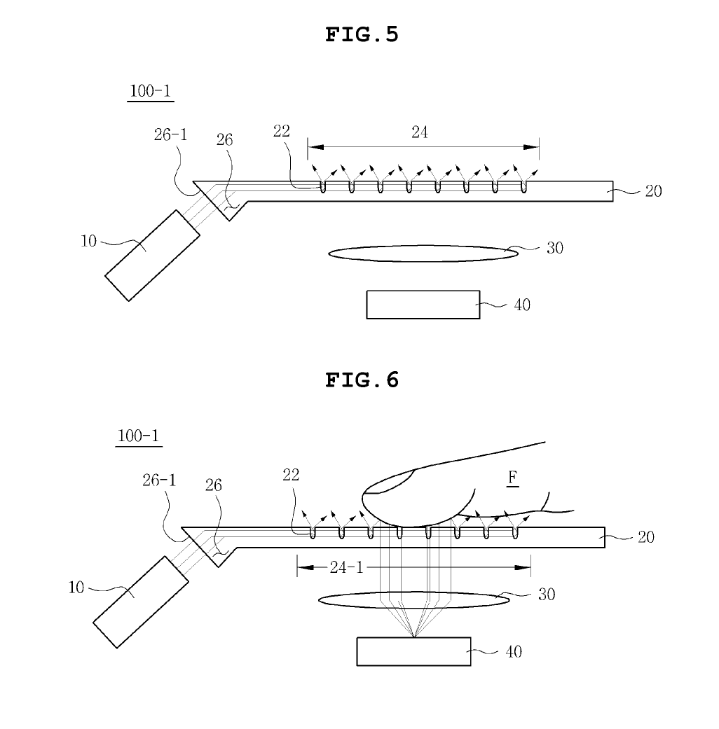

FIG. 1 is a sectional view illustrating an optical pointing device 100-1 according to a first embodiment of the present invention, FIG. 2 is a plan view illustrating a guiding plate 20 included in the optical pointing device 100-1 according to the first embodiment of the present invention, FIGS. 3 and 4 are a sectional view and a plan view, respectively, illustrating a modification of the optical pointing device shown in FIGS. 1 and 2, and FIGS. 5 and 6 are sectional views illustrating the operation of the optical pointing device according to the first embodiment. The optical pointing device 100-1 according to this embodiment will be described below with reference to the drawings.

As shown in FIGS. 1 and 2, the optical pointing device 100-1 according to this embodiment includes a light source 10, a guiding plate 20, a first condensing part 30, and an image sensor 40.

The light source 10 emits light which is used as a source for determining the movement of a subject. The light source 10 emits visible light or far red light of from 700 to 800 nm. A light element such as an LED may be used as the light source 10.

The guiding plate 20 is a planar member having grooves 22 which are formed in an outer exposed surface thereof in a thickness direction. Since light moves through the inside of the guiding plate 20, the guiding plate 20 is preferably made of a transparent material which permits the passage of light.

Light emitted from the light source 10 is incident on the guiding plate 20, moves along the guiding plate 20, is diffused when it collides with the grooves 22, and is thus emitted to the outside of the guiding plate 20. Since the light moving along the guiding plate 20 is diffused from the grooves 22 to the outside of the guiding plate 20, it is not necessary to directly apply light to the subject F unlike a conventional pointing device, and a lens or mirror for directly transmitting light to the subject may be omitted, and the light source 10 may be positioned at a side of the guiding plate 20. Consequently, a slim structure is achieved and the degree of freedom increases when designing the optical pointing device.

Such a groove 22 may be formed to have the shape of a dot, as shown in FIGS. 1 and 2. The dot-shaped groove 22 may have a ‘V’- or ‘U’-shaped cross-section when viewed in a vertical cross-section, or have a ‘rectangular’ or ‘circular’ section when viewed in a horizontal cross-section.

The dot-shaped grooves 22 may be preferably formed in a matrix array. Since the grooves 22 have the matrix array, light scattered from the grooves 22 may be uniformly emitted to the outside of a reading region 24. Thus, regardless of the position of the subject F on the reading region 24, light reflected from the subject F can be uniformly provided to the image sensor 40, and the image sensor 40 can detect the fine movement of the subject F. In FIG. 2, the dot-shaped grooves 22 are formed in the matrix array of 4×8. However, such an array is only one example, and may be changed according to the intended shape and area of the reading area 24.

Further, as shown in FIGS. 3 and 4, a groove 22′ may be formed to have the shape of a slit extending in a length or width direction. Preferably, the slit-shaped groove 22′ may comprise a plurality of parallel grooves to provide uniform light to the subject F placed on the reading region 24. Meanwhile, as one example, in FIGS. 3 and 4, four slit-shaped grooves 22′ are formed in the width direction.

Further, in order to enable light emitted from the light source 10 to be easily incident on the guiding plate 20, the guiding plate 20 may include a light incident part 26 which is thicker than another region (e.g. a reading region) of the guiding plate 20 and has a light incident surface 26-1. Such a light incident part 26 may be formed on a side of the guiding plate 20, and the light incident surface 26-1 may be formed to be at an angle to the guiding plate 20.

Further, in order to prevent the loss of light which passes through the inside of the guiding plate, a light blocking film (or a light blocking agent) for preventing the emission of light may be formed on a region of the guiding plate 20 other than a region (hereinafter referred to as a corresponding region 24-1: see FIG. 6) corresponding to a reading region 24 of the outer surface and a reading region 24 of the inner surface.

Meanwhile, in the description, the reading region 24 is defined as a region which has grooves 22 on the outer surface of the guiding plate 20 and is in contact with the subject F such as a finger. That is, the reading region 24 means a region in which light diffused in the grooves 22 collides with the subject F, when the subject F comes into contact with the outer surface of the guiding plate 20.

Further, the corresponding region is a region through which reflected light passes when light reflected from the subject F is incident on the reading region 24 again and moves to the first condensing part 30 which will be described below in detail, and is defined as any region which is opposite to the reading region 24 but is positioned on the same line as the reading region 24.

Further, the first condensing part 30 is positioned under the guiding plate 20, thus condensing light reflected from the subject F and transmitting the light to the image sensor 40 which will be described below in detail.

The first condensing part 30 may comprise a lens or a structure having a light condensing function, similarly to the lens. Light reflected from the subject F may be diffused in every direction. Some of the light passes through the reading region 24 and the corresponding region to the lower portion of the guiding plate 20. The first condensing part 30 condenses the light and then transmits the light to the image sensor 40.

Preferably, the reading region 24 of the guiding plate 20, the first condensing part 30, and the image sensor 40 are arranged on a vertical line, that is, on the same line. When the reading region 24, the first condensing part 30 and the image sensor 40 are not arranged on a vertical line, the curvature of the first condensing part 30 is changed so that light is condensed on the image sensor 40.

Meanwhile, the distance between the guiding plate 20 and the first condensing part 30 and the distance between the first condensing part 30 and the image sensor 40 may be changed according to the focus of an image which is formed on the image sensor 40 after light reflected from the subject F is condensed.

The image sensor 40 is located under the first condensing part 30, detects a change in the image formed by condensed light and then converts the change into an electric signal. Such an image sensor 40 may comprise a CCD or CMOS sensor.

Although not shown in FIGS. 1 to 4, the optical pointing device 100-1 may further include a protective casing which holds the light source 10, the guiding plate 20, the first condensing part 30, and the image sensor 40. The optical pointing device may be applied to a portable device in the state in which the above-mentioned components are mounted on the protective casing. For example, the guiding plate 20 may be mounted to the top of the box-shaped casing, the light source 10 may be mounted to the side of the guiding plate 20, and the image sensor 40 mounted on a printed circuit board (PCB) may be mounted to the bottom of the casing. Here, the guiding plate 20 is mounted to the casing in such a way that the reading region 24 thereof is exposed to the outside, and the image sensor 40 is connected to the portable device via the PCB.

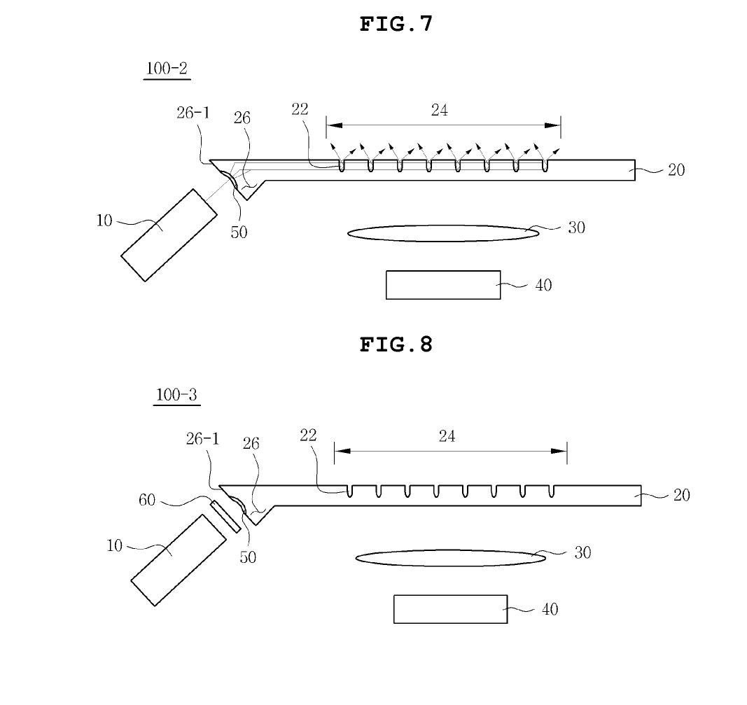

The operating principle of the optical pointing device 100-1 shown in FIGS. 1 and 2 will be described with reference to FIGS. 5 and 6. It is obvious that the operating principle which will be described below can be also applied to an optical pointing device 100-1′ of FIGS. 3 and 4.

First, when the subject F is not located at the reading region 24 of the guiding plate 20 as shown in FIG. 5, light emitted from the light source 10 moves along the guiding plate 20, collides with the grooves 22 to be diffused, and then is emitted to the outside of the guiding plate 20. Since the subject F is not located at the reading region 24 of the guiding plate 20, there is no light which is reflected and enters the guiding plate. Therefore, an image formed on the image sensor 40 is not changed.

Meanwhile, when the subject F is located at the reading region 24 of the guiding plate 20 as shown in FIG. 6, light diffused in the grooves 22 is reflected from the subject F, passes through the reading region 24 of the guiding plate 20 and the corresponding region 24-1 and then is incident on the inside of the optical pointing device 100-1. The light is condensed by the condensing part 30 and forms an image on the image sensor 40. The image sensor 40 converts the image into an electric signal. As the subject F moves, the electric signal converted by the image sensor 40 is changed, and a control unit, which is not shown in the drawings, is a control means included in a portable device equipped with the optical pointing device and is connected to the image sensor 40, analyzes a change of the electric signal, thus detecting the movement of the subject F.

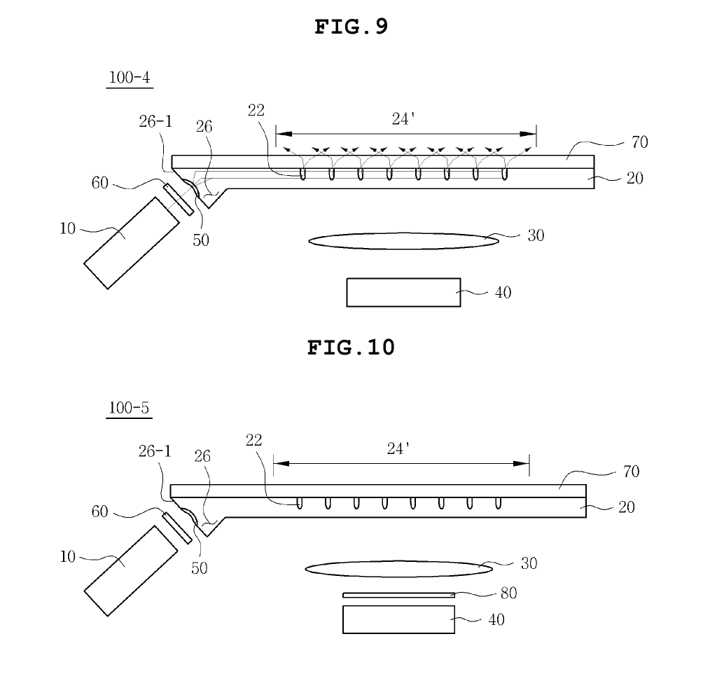

FIGS. 7 to 11 are sectional views illustrating optical pointing devices according to second to sixth embodiments of the present invention. The optical pointing devices according to the respective embodiments will be described below with reference to the accompanying drawings. The optical pointing devices according to the second to sixth embodiments which will be described below are based on the optical pointing device 100-1 of FIGS. 1 and 2, and it is obvious that they may be equally applied to the optical pointing device 100-1′ of FIGS. 3 and 4.

As shown in FIG. 7, the optical pointing device 100-2 according to the second embodiment of the present invention further includes a second condensing part 50 between a light source 10 and a guiding plate 20. Especially in the case where the light incident part 26 is formed on the guiding plate 20, the second condensing part 50 is preferably provided on a light incident surface 26-1 of the guiding plate 20. The second condensing part 50 serves to condense light emitted from the light source 10, thus preventing the loss of light. The second condensing part 50 may comprise a lens.

Further, as shown in FIG. 7, the second condensing part 50 preferably comprises a diffusion lens. A first lens surface of the diffusion lens condenses light emitted from the light source 10, and a second lens surface diffuses incident light and emits the light to the guiding plate 20. Thus, the curvature radius of the second lens surface is larger than that of the first lens surface, and the second lens surface is positioned to face the guiding plate 20. Meanwhile, as shown in FIG. 7, the diffusion lens may be installed such that the second lens surface is embedded in the light incident surface 26-1.

As such, if the optical pointing device 100-2 further includes the second condensing part 50, the loss of light is prevented, thus reducing the power consumption of the light source 10. Particularly, in the case of mounting the optical pointing device 100-2 to a portable device, the portable device uses a rechargeable power source, thus minimizing the power consumption of the portable device.

As shown in FIG. 8, the optical pointing device 100-3 according to the third embodiment of the present invention further includes a first polarizing part 60 having the first directivity between a light source 10 and a guiding plate 20.

Light emitted from the light source 10 passes through the first polarizing part 60 and is changed into a first polarized state having the first directivity, prior to moving to the guiding plate 20. Some of the light emitted from the light source 10 collides with the grooves 22 of the guiding plate 20 to be diffused and emitted to the outside, whereas some of the light may be transmitted to an image sensor 40 through a corresponding region on the inner surface of the guiding plate 20. Since the light causes noise in the image sensor 40, the first polarizing part 60 can reduce noise which is directly transmitted to the image sensor 40.

Meanwhile, light diffused in the grooves 22 has no polarization. Thus, light which is diffused in the grooves 22 and thereafter is reflected from the subject F transmits light having no directivity to the image sensor 40, regardless of the existence of the first polarizing part 60.

As shown in FIG. 9, the optical pointing device 100-4 according to the fourth embodiment of the present invention further includes a protective layer 70 on a guiding plate 20. The protective layer 70 may comprise a plastic film or a plastic plate of predetermined strength.

The protective layer 70 prevents the guiding plate 20 from being damaged, and a subject F such as a finger is in contact with the protective layer 70, so that a reading region 24′ is formed on the protective layer 70. Here, while light diffused in grooves 22 passes through the protective layer 70, the light is refracted and emitted to the outside. Thus, the reading region 24′ formed on the protective layer 70 is larger than the reading region 24 (see FIG. 5) which is directly formed on the guiding plate 20.

If impurities enter the grooves 22, the impurities may hinder the diffusion of light and limit the light emitted to the outside to a specific direction, thus making it difficult to detect movement of the subject F. Therefore, in order to prevent impurities from entering the grooves 22, the protective layer 70 is preferably formed to cover the grooves 22 which are formed in the guiding plate 20.

Preferably, the protective layer 70 comprises a visible light blocking film so as to eliminate visible light which moves from an outside into the optical pointing device 100-4. When the protective layer 70 comprises the visible light blocking film, damaging the guiding plate 20 is prevented, the entrance of impurities into the grooves 22 is prevented, and noise transmitted to the image sensor 40 is eliminated. Here, the light source 10 emits light (e.g. far red light) other than visible light, and the emitted light freely passes through the protective layer 70, thus detecting movement of the subject F. Hence, even if the visible light blocking film is used, the optical pointing device 100-4 may be normally operated.

As shown in FIG. 10, the optical pointing device 100-5 according to the fifth embodiment of the present invention further includes a visible light blocking part 80 between a guiding plate 20 and an image sensor 40. The visible light blocking part 80 performs the same function as the above-mentioned visible light blocking film. When the visible light blocking part 80 is positioned between a first condensing part 30 and the image sensor 40 as shown in FIG. 10, visible light is blocked in a state in which light is condensed, so that it is more efficient to eliminate noise transmitted to the image sensor 40. Meanwhile, the visible light blocking part 80 may be positioned between the guiding plate 20 and the first condensing part 30 so as to perform the same function.

Further, when the protective layer 70 comprises the visible light blocking film, the protective layer 70 and the visible light blocking part 80 of this embodiment may be selectively used. That is, if the protective layer 70 does not perform the function of blocking the visible light, the visible light blocking part 80 of this embodiment may be adopted. Meanwhile, if the protective layer 70 comprises the visible light blocking film, the visible light blocking part 80 may be omitted.

As shown in FIG. 11, the optical pointing device 100-6 according to the sixth embodiment of the present invention further includes a second polarizing part 90 which is positioned between a guiding plate 20 and an image sensor 40 and has the second directivity.

The second polarizing part 90 permits the passage of only light having a specific directivity, thus preventing external noise from being transmitted to the image sensor 40. Thus, even if external light enters the optical pointing device, most of the light is not transmitted to the image sensor 40 and only the light having the second directivity passes through the image sensor 40. Such a second polarizing part 90 can eliminate noise, directly transmitted from the light source 10 to the image sensor 40, as well as noise caused by external light.

Particularly, when light passing through the first polarizing part 60 goes through a corresponding region of the guiding plate 20 into the image sensor 40, the second polarizing part 90 having directivity different from that of the first polarizing part 60 serves as a filter, thus minimizing noise transmitted to the image sensor 40. Therefore, in order to minimize noise transmitted to the image sensor 40, the directivity of the first polarizing part 60 is preferably perpendicular to that of the second polarizing part 90.

Further, the second polarizing part 90 may be a polarizing film having the second directivity and may be formed on the lower surface of the guiding plate 20. A plastic adhesive may be applied to a contact surface between the second polarizing part 90 and the guiding plate 20 so that the second polarizing part 90 is integrated with the guiding plate 20. Further, if the second polarizing part 90 comprises a film type polarizing part 90, the slimness of the optical pointing device 100-6 is achieved.

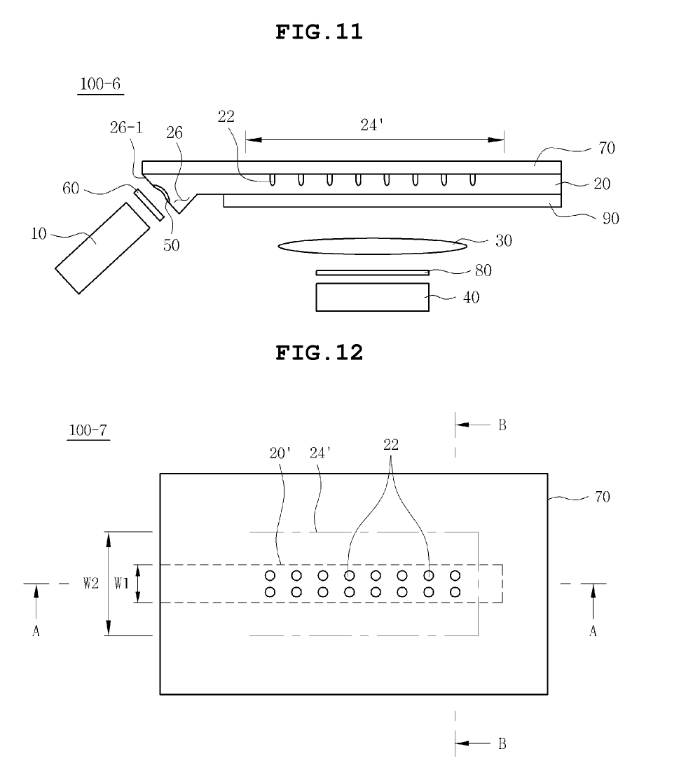

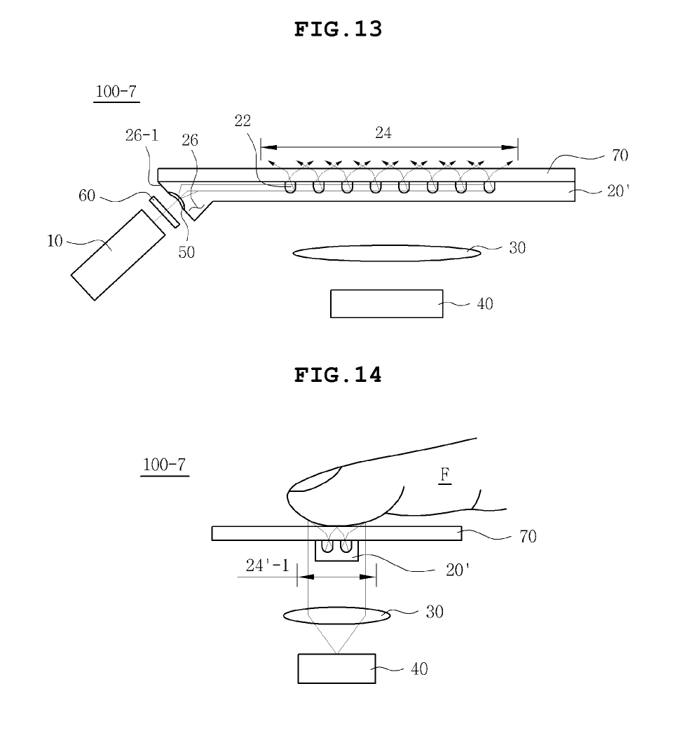

FIG. 12 is a plan view illustrating an optical pointing device 100-7 according to a seventh embodiment of the present invention, FIG. 13 is a sectional view taken along line A-A of FIG. 12 illustrating the optical pointing device 100-7 and, and FIG. 14 is a sectional view taken along line B-B of FIG. 12 illustrating the optical pointing device 100-7.

The optical pointing device 100-7 of FIG. 12 is different from the optical pointing device 100-4 of FIG. 7 in that an optical waveguide 20′ is used in place of the guiding plate 20. The optical waveguide 20′ loses a small amount of light, and light is not emitted to a corresponding region of the inner surface of the optical waveguide 20′, so that noise transmitted to the image sensor 40 is reduced.

As shown in FIGS. 13 and 14, after light diffused in grooves 22′ of the optical waveguide 20′ is reflected from a subject F, the light does not pass through the optical waveguide 20′ but is directly incident on a first condensing part 30. Thus, in order to prevent the optical waveguide 20′ from impeding the transmission of the light reflected from the subject F to the first condensing part 30, a width W1 of the optical waveguide 20′ is preferably smaller than a width W2 of a reading region 24′ formed on the protective layer 70.

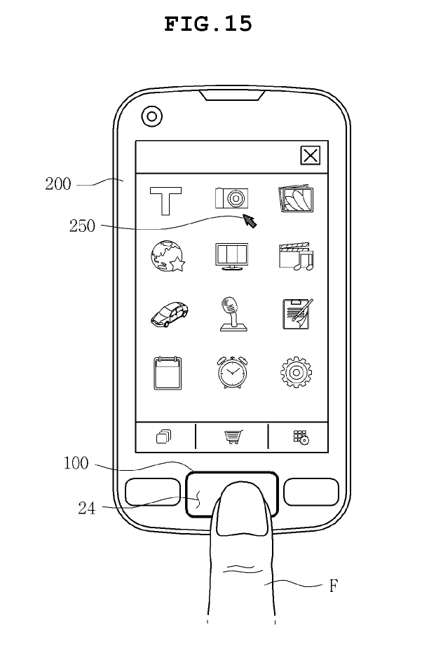

FIG. 15 illustrates a portable device 200 equipped with an optical pointing device 100 according to a preferred embodiment of the present invention. FIG. 15 illustrates a mobile phone as an example of the portable device 200. However, a personal portable device to which the optical pointing device 100 according to the present invention is applicable is a portable electric device such as a personal digital assistant (PDA), a smart phone, a handheld PC, or an MP3 player, and is provided with a communication module such as a code division multiplexing access (CDMA) module, a Bluetooth module, an IrDA, or a wire or wireless LAN card, and is referred to as a device which includes a microprocessor performing a multimedia playing function to have calculating ability.

The portable device 200 equipped with the optical pointing device 100 includes a display part such as an LCD and a control unit such as a microprocessor. Here, the reading region 24 of the optical pointing device 100 is exposed to the outside.

When the optical pointing device 100 of the mobile device 200 is being operated, a pointer 250 which moves according to the instructions of the control unit appears on the display part.

As the subject F moves the reading region 24 of the optical pointing device 100, the image sensor of the optical pointing device 100 acquires a changed image of the subject F, converts the image into an electric signal, and transmits the signal to the control unit. The control unit calculates the electric signal transmitted from the image sensor to determine the moving direction of the subject F, and performs control such that the pointer 250 of the display part moves in the moving direction of the subject F.

Even if many pieces of information are simultaneously provided on the display part of the portable device 250, and an icon showing each piece of information is small, a desired icon can be precisely selected by finely adjusting the pointer 250 using the optical pointing device 100.

As described above, the present invention is provided with an optical pointing device, in which light is not directly radiated from a light source to a subject, but is radiated to the subject through a guiding plate, thus realizing a slim structure.

Further, the present invention is provided with an optical pointing device, in which light radiated from a light source is diffused in a groove formed in a guiding plate and then is incident on a subject, so that a reading region for sensing the movement of the subject is increased, and in which light is not directly radiated to the subject, so that a plurality of lenses or mirrors for condensing light on the subject may be omitted.

Further, the present invention is provided with an optical pointing device, which uses a polarizing part, thus minimizing noise transmitted to an image sensor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical pointing device, comprising:
a light source emitting light;
a guiding plate including grooves formed in a thickness direction thereof, light emitted from the light source being incident on the guiding plate to move therealong, and the moving light colliding with the grooves to be diffused therefrom;
a first condensing part provided under the guiding plate, and condensing light which is diffused from the grooves and reflected from a subject placed on the guiding plate; and
an image sensor provided under the first condensing part.

2. The optical pointing device as set forth in claim 1, wherein the light source is positioned at a side of the guiding plate.

3. The optical pointing device as set forth in claim 1, further comprising:
a second condensing part provided between the light source and the guiding plate.

4. The optical pointing device as set forth in claim 3, wherein the second condensing part is a diffusion lens.

5. The optical pointing device as set forth in claim 1, further comprising:
a first polarizing part provided between the light source and the guiding plate and having first directivity.

6. The optical pointing device as set forth in claim 1, wherein the grooves have shape of dots and are formed in a matrix array.

7. The optical pointing device as set forth in claim 1, wherein the grooves have shape of slits extending in a length or width direction.

8. The optical pointing device as set forth in claim 1, further comprising:
a protective layer formed on the guiding plate.

9. The optical pointing device as set forth in claim 8, wherein the protective layer is formed to cover the grooves.

10. The optical pointing device as set forth in claim 8, wherein the protective layer is a visible light blocking film which blocks external light of a visible light band.

11. The optical pointing device as set forth in claim 8, wherein the guiding plate is an optical waveguide.

12. The optical pointing device as set forth in claim 1, further comprising:
a second polarizing part provided between the guiding plate and the image sensor, and having second directivity.

13. The optical pointing device as set forth in claim 12, wherein the second polarizing part is a polarizing film formed on a lower surface of the guiding plate.

14. The optical pointing device as set forth in claim 1, further comprising:
a visible light blocking part provided between the guiding plate and the image sensor.

15. The optical pointing device as set forth in claim 1, further comprising:
a first polarizing part provided between the light source and the guiding plate and having first directivity; and
a second polarizing part provided between the guiding plate and the image sensor and having second directivity.

16. The optical pointing device as set forth in claim 15, wherein the directivity of the first polarizing part is perpendicular to the directivity of the second polarizing part.
